(19) United States
(12) Patent Application Publication
(10) Pub. No.: US 2008/0195778 A1
(43) Pub. Date: Aug. 14, 2008

(54) Control Method and System of Computer Peripheral

(75) Inventor: Yen-Liang Kuan, Sijhih City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BEHAVIOR TECH COMPUTER CORP., Sijhih City (TW)

(21) Appl. No.: 11/856,188

(22) Filed: Sep. 17, 2007

(30) Foreign Application Priority Data
Feb. 14, 2007 (TW) 96105535

(51) Int. Cl. G06F 13/12

(52) U.S. Cl. 710/63

(57) ABSTRACT

A control method of an input device is provided. Input signals are received and whether the input device is in a sustained mode is determined. A reference frequency of the input signals is calculated. The reference frequency may be the maximum frequency or the average frequency of the input signals. Output signals are transmitted lastingly when the input device is in the sustained mode. The frequency of the output signals is proportional to the reference frequency. A control system of the input device is also provided.

### RELATED APPLICATIONS

This application claims the priority benefit of Taiwan application serial no. 96105535, filed Feb. 14, 2007, the full disclosure of which is incorporated herein by reference.

### BACKGROUND

1. Field of Invention

The present invention relates to a control method and a control system of a computer peripheral. More particularly, the present invention relates to a control method and a control system for controlling a sustaining function of a computer peripheral.

2. Description of Related Art

With the development of the computer and Internet, users are able to utilize computers to search data, download data, play on-line games, receive and send emails or talk with others on the Internet. Accordingly, the computers become must-have utilities in people's daily lives. For improving the convenience, the computer is usually equipped with various peripherals, such as a keyboard, a mouse and a touch pad. By utilizing the peripherals above, the user is able to generate a plurality of input signals by pressing, moving or scrolling a detecting device. The peripherals can transform a plurality of input signals into a plurality of output signals, and send the plurality of output signals to the computer for controlling the computer or inputting data to the computer.

When the user browses through data on a computer, he or she may often need to scroll the computer pages. In the prior art, the user can scroll a scrolling wheel of the mouse to scroll the pages. However, if there is a great quantity of pages, the user has to scroll the scrolling wheel continuously by his or her finger, which is very inconvenient. Besides, the continuous scrolling may damage the scrolling wheel.

Furthermore, when the user plays a game on-line, it is often necessary to keep pressing down a same key. For example, a key corresponding to shooting in a gun shooting game is often pressed, such that the key may be broken accordingly.

For the foregoing reasons, there is a need for a control method and a control system of a computer peripheral, wherein the computer peripheral is capable of inputting signals to a computer successively without keeping mechanical motions or requiring a user keeping entering signals to the computer.

### SUMMARY

It is therefore an aspect of the present invention to provide a control system and related method of a computer peripheral, such that allows the user to input data to a computer successively without successive actions for entering signals.

It is another aspect of the present invention to provide a control system and related method of a computer peripheral, such that allows the computer peripheral to input data to a computer successively without successive machine motions.

In accordance with the foregoing and other aspects of the present invention, a control method of a computer peripheral is introduced. The control method of the present invention includes receiving a plurality of input signals, determining whether the computer peripheral is in a sustained mode, calculating a reference frequency if the computer peripheral is in a sustained mode, and transmitting a plurality of output signals successively to a computer, wherein a frequency of the plurality of output signals is proportional to the reference frequency.

In accordance with the foregoing and other aspects of the present invention, another control method of a computer peripheral is further introduced. The control method of the present invention includes receiving a plurality of input signals, calculating a reference frequency of receiving input signals, determining if the reference frequency is higher than a predetermined frequency, and transmitting a plurality of output signals successively to a computer when the reference frequency is higher than the predetermined frequency, wherein a frequency of the plurality of output signals is proportional to the reference frequency.

In accordance with the foregoing and other aspects of the present invention, a control system of a computer peripheral is introduced as well. The control system of the present invention includes a receiving module for receiving a plurality of input signals, a determining module for determining whether the computer peripheral is in a sustained mode, a calculating module for calculating a reference frequency of the receiving input signals if the computer peripheral is in a sustained mode, and a transmitting module for transmitting a plurality of output signals successively to the computer, wherein a frequency of the plurality of output signals is proportional to the reference frequency.

In accordance with the foregoing and other aspects of the present invention, another control system of a computer peripheral is further introduced. The control system of the present invention includes a receiving module for receiving a plurality of input signals, a calculating module for calculating a reference frequency of receiving input signals, a determining module for determining whether the reference frequency is higher than a predetermined frequency, and a transmitting module for transmitting a plurality of output signals successively to the computer when the reference frequency is higher than the predetermined frequency, wherein a frequency of the plurality of output signals is proportional to the reference frequency.

According to an embodiment of the control system and method of a computer peripheral of the present invention, the computer peripheral can transmits a plurality of output signals successively, such that the user can successively control the computer or input data to the computer without keeping entering signals.

According to an embodiment of the control system and method of a computer peripheral of the present invention, the user does not need to keep entering signals, such that the peripheral can control the computer or input data to the computer without successive machine motions.

These and other features, aspects, and advantages of the present invention will become better understood with reference to the following description, figures, and appended claims.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a diagram of an embodiment of the computer and the peripheral of the present invention;

FIG. 2 is a block diagram of an embodiment of the control system of the present invention;

FIG. 3 is a flow chart of an embodiment of the control method of the present invention;

FIG. 4 is a block diagram of another embodiment of the control system of the present invention; and

FIG. 5 is a flow chart of another embodiment of the control method of the present invention.

### DESCRIPTION OF THE PREFERRED EMBODIMENTS

When a user browses through data of a great quantity via computer or plays a computer game, he or she may often need to scroll pages or enter signals successively. In the prior art, the user needs to keep pressing, clicking or scrolling to enter signals successively, and the computer peripherals need to perform machine motions successively, which brings the user inconvenience and destroys the computer peripherals easily. It is disclosed in the present invention a control system and related method of a computer peripheral. The computer peripheral according to the present invention may be set into a sustained mode, taking an input frequency of the peripherals as a reference and successively generating a plurality of output signals. Therefore, it is not necessary for the user to keep entering signals by keeping pressing, clicking or scrolling, for example, and it is not needed for the computer peripheral to keep performing the machine motions to successively enter signals to the computer.

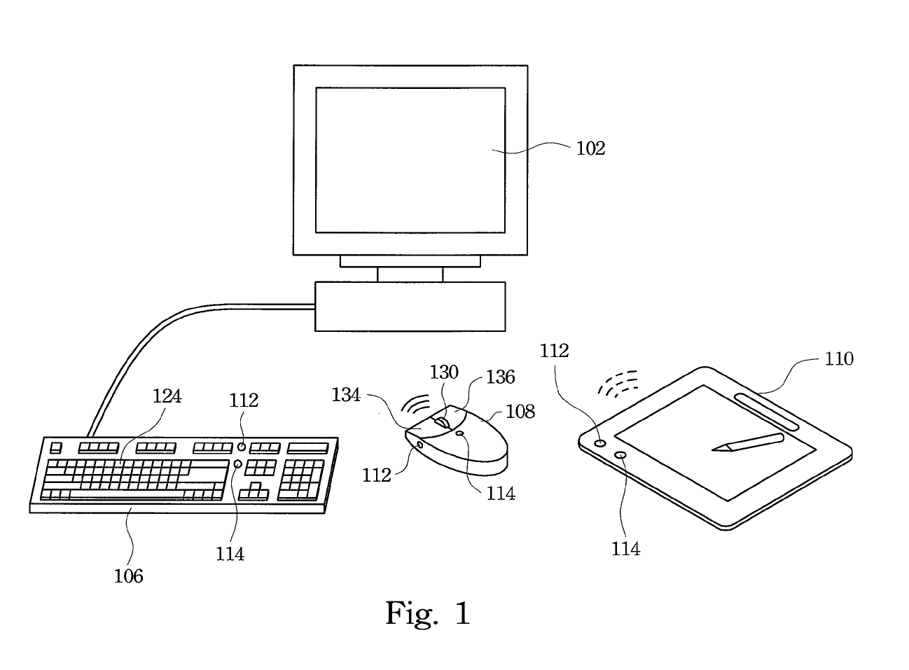

FIG. 1 illustrates a diagram of an embodiment of the computer and the peripheral of the present invention. A computer 102 and a peripheral 104, for example, a keyboard 106, a mouse 108 or a touchpad 110, may couple to each other via wire or wireless. The user can utilize the peripheral 104 to transmit a control signal or input data to the computer 102. The peripheral 104 may have a switch button 112 and an indication unit 114. The switch button 112 is utilized to switch the peripheral 104 into a sustained mode. The indication unit 114 is utilized to display whether the peripheral 104 is in a sustained mode. For instance, an indication unit 114 may be an indicating light installed on a housing of the peripheral 104. Otherwise, the indication unit may be installed internally within the peripheral 104, such that the color appears on a transparent or a light or previous housing of the peripheral 104 may vary corresponding to the mode of the peripheral 104.

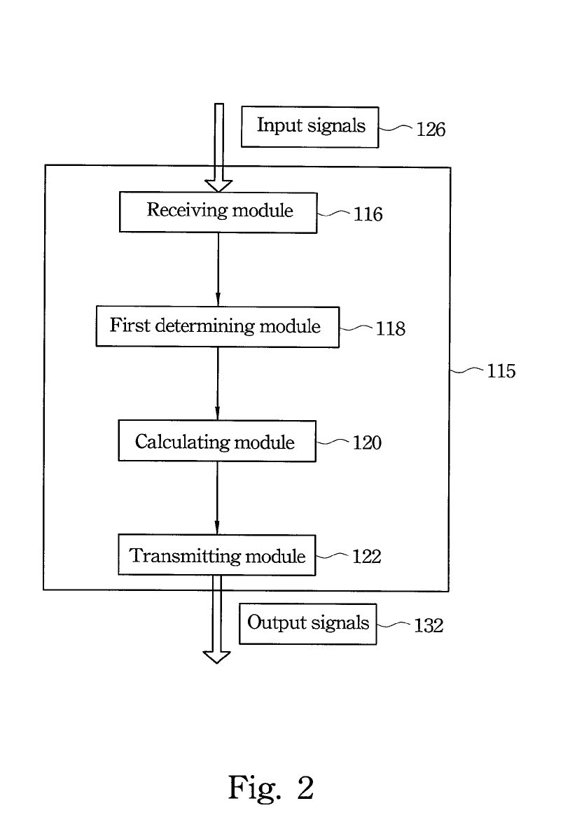

FIG. 2 illustrates a block diagram of an embodiment of the control system of the present invention. A first control system 115 includes a receiving module 116, a first determining module 118, a calculating module 120 and a transmitting module 122. The first control system 115 may be implemented by hardware, such as circuits, or by software, such as programs. For instance, the internal circuit board of the peripheral 104 may be utilized to implement the first control system 115. Besides, the firmware of the peripheral 104 may be utilized to implement the first control system 115 as well.

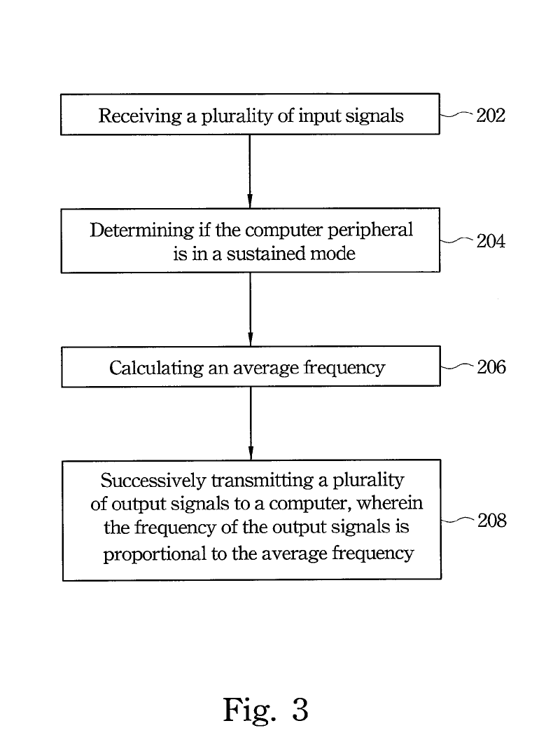

FIG. 3 illustrates a flow chart of an embodiment of the control method of the present invention. Take the keyboard 106 for example. In the first step, the user can press down a switch button 112 of the keyboard 106, such that sets the keyboard 106 to a sustained mode and lights an indication unit 114 of the keyboard 106 to notify the user that the keyboard 106 is in the sustained mode. Next, the user successively presses the key 124 for several times in order to generate a plurality of input signals 126. Please note that the user can successively press the same key for several times or successively press different keys alternately. In step 202, the first control system 115 receives the plurality of input signals 126 via the receiving module 116. In step 204, the first determining module 118 determines if the keyboard 106 is in a sustained mode. For example, the first determining module 118 detects whether the switch button 112 of the keyboard 106 is pressed to determine if the keyboard 106 is set in a sustained mode. In step 206, if the keyboard 106 is in a sustained mode, the calculating module 120 calculates a reference frequency of receiving input signals. The reference frequency may be a maximum value of frequencies of the plurality of input signals 126, an average of the first three largest values of the frequencies of the plurality of input signals 126, an average of the frequencies of the plurality of input signals 126, or other predetermined value. In step 208, the transmitting module 122 successively outputs a plurality of output signals 132 to the computer 102. The plurality of output signals 132, for example, may comprise standard keyboard signals generated by the transmitting module 122 according to the keys pressed by the user, wherein the frequency of the plurality of output signals 132 is proportional to the reference frequency, such that the computer 102 successively receives input data from the transmitting module 122 at the frequency of the plurality of output signals 132. Since the frequency of the plurality of output signals 132 is proportional to the reference frequency, the faster the user successively presses the key 124, the faster the computer 102 receives the input data. Please note that, when the user successively presses different keys, the transmitting module 122 successively and repeatedly transmits data corresponding to these keys. In a preferable embodiment, when the user wants to stop inputting data, he or she may press down another key of the keyboard 106 to stop inputting data.

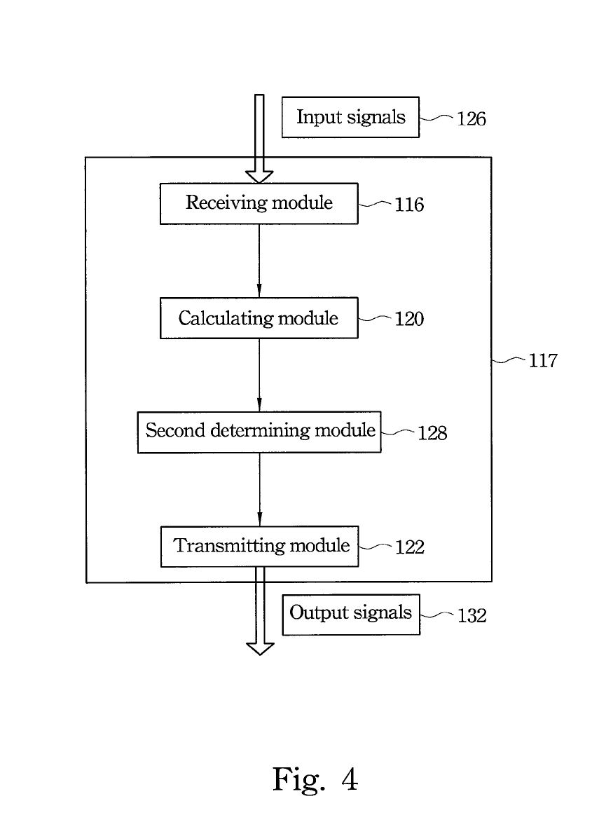

FIG. 4 illustrates a block diagram of another embodiment of the control system of the present invention. A second control system 117 includes a receiving module 116, a second determining module 128, a calculating module 120 and a transmitting module 122. The second control system 117 may be implemented by hardware, such as circuits, or by software, such as programs. For instance, the internal circuit board of the peripheral 104 may be utilized to implement the second control system 117. Besides, the firmware of the peripheral 104 may be utilized to implement the second control system 117 as well.

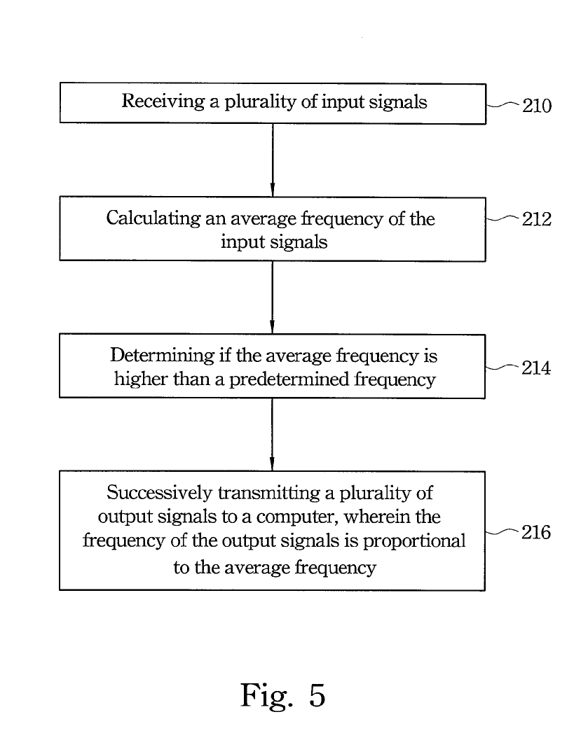

FIG. 5 illustrates a flow chart of another embodiment of the control method of the present invention. Take the mouse 108 for example. When the user scrolls the scrolling wheel 130, the scrolling wheel 130 generates scroll signals discontinuously and regularly, generating a plurality of input signals 126. In step 210, the second control system 117 receives the plurality of input signals 126 via the receiving module 116. Next, the calculating module 120 calculates a reference frequency of input signals 126 in step 212. The reference frequency may be a maximum value of frequencies of the plurality of input signals 126, an average of the first three largest values of the frequencies of the plurality of input signals 126, an average of the frequencies of the plurality of input signals 126, or other predetermined value. In step 214, the second determining module 128 determines if the reference frequency is higher than a predetermined frequency. Next, when the reference frequency is higher than the predetermined frequency, the mouse 108 enters a sustained mode, and the transmitting module 122 successively outputs a plurality of output signals 132 to the computer 102 in step 216. The plurality of output signals 132 may be, for example, scrolling signals of the computer 102 generated by the transmitting module 122 according to the plurality of input signals 126, wherein a frequency of the scrolling signals is proportional to the reference frequency of input signals 126, such that the scrolling signals of the computer 102 are successively scrolled up or down at the reference frequency. In other words, the plurality of output signals 132 may be extension of the plurality of input signals 126. For instance, the calculating module 120 calculates the reference frequency, the second determining module 128 determines if the mouse is in a sustained mode and transmits the scrolling signals to the transmitting module, and the transmitting module 122 then outputs identical scrolling signals to the computer 102 according to the reference frequency. Since the frequency of the plurality of output signals 132 is proportional to the reference frequency, the scrolling speed of the computer pages of the computer 102 is proportional to the reference frequency as well. Therefore, the faster the user scrolls the scrolling wheel 130, the faster the computer pages of the computer 102 are scrolled successively. In a preferable embodiment, when the reference frequency of input signals is higher than the predetermined frequency, the mouse 108 is set into the sustained mode, and an indication unit 114 of the mouse 108 is lighted to illustrate that the mouse 108 is in a sustained mode. In another preferable embodiment, the user can press a switch button 112 of the mouse 108 to force the mouse 108 to switch to a sustained mode and light the indication unit 114 of the mouse 108. If the user wants to stop the page scrolling of the computer 102, he or she can press the scrolling wheel 130 or any other key of the mouse 108, for example, a left key 134, a right key 136 or the switch button 112 of the mouse 108, to stop the page scrolling of the computer 102.

Please note that, the control system and related method of a computer peripheral provided by the present invention may not only be applied to the keyboard 106 and the mouse 108, but also to the touchpad 110 and other computer peripherals. For example, a user may move his or her finger on the touchpad 110 and then generates a plurality of input signals thereby, such that the computer 102 may receive input data or demands successively according to a frequency of the plurality of input signals.

According to the aforementioned embodiments, the present invention has the advantages as follows.

1. According to a preferable embodiment of the control system and method of a computer peripheral introduced by the present invention, it is not necessary for a user to successively enter signals but can still successively control the computer or input data to the computer.

2. According to a preferable embodiment of the control system and method of a computer peripheral introduced by the present invention, it is not necessary for a peripheral to perform machinery motions successively but can still successively control the computer or input data to the computer.

Although the present invention has been described in considerable detail with reference to certain preferred embodiments thereof, other embodiments are possible. Their spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A control method of a computer peripheral, the method comprising:
receiving a plurality of input signals;
determining whether the computer peripheral is in a sustained mode;
calculating a reference frequency of receiving input signals when the computer peripheral is in a sustained mode; and
transmitting a plurality of output signals successively to a computer, wherein a transmitting frequency of the plurality of output signals is proportional to the reference frequency.

2. The method of claim 1, wherein the reference frequency is a maximum value of frequencies of receiving the plurality of input signals, an average of the first three largest values of the frequencies of receiving the plurality of input signals, or an average of the frequencies of receiving the plurality of input signals.

3. The method of claim 1, further comprising a step of switching the computer peripheral to the sustained mode.

4. The method of claim 3, further comprising a step of lighting an indication unit.

5. The method of claim 1, wherein the plurality of output signals is a plurality of scrolling signals of computer pages.

6. The method of claim 1, wherein the plurality of output signals is a plurality of key-pressing signals.

7. A control method of a computer peripheral, the method comprising:
receiving a plurality of input signals;
calculating a reference frequency of receiving input signals;
determining if the reference frequency is higher then a predetermined frequency; and
transmitting the plurality of output signals successively to a computer when the reference frequency is higher than the predetermined frequency, wherein a transmitting frequency of the plurality of output signals is proportional to the reference frequency.

8. The method of claim 7, wherein the reference frequency is a maximum value of frequencies of the plurality of receiving input signals, an average of the first three largest values of the frequencies of the plurality of receiving input signals, or an average of the frequencies of the plurality of receiving input signals.

9. The method of claim 7, further comprising a step of lighting an indication unit when the reference frequency is higher than the predetermined frequency.

10. The method of claim 7, wherein the plurality of output signals is a plurality of scrolling signals of computer pages.

11. The method of claim 7, wherein the plurality of output signals is a plurality of key-pressing signals.

12. A control system of a computer peripheral, the control system comprising:
a receiving module for receiving a plurality of input signals;
a determining module for determining whether the computer peripheral is in a sustained mode;
a calculating module for calculating a reference frequency of receiving input signals when the computer peripheral is in a sustained mode; and
a transmitting module for transmitting a plurality of output signals successively to the computer, wherein a transmitting frequency of the plurality of output signals is proportional to the reference frequency.

13. The control system of claim 12, wherein the reference frequency is a maximum value of frequencies of the plurality of receiving input signals, an average of the first three largest values of the frequencies of the plurality of receiving input signals, or an average of the frequencies of the plurality of receiving input signals.

14. The control system of claim 12, wherein the plurality of output signals is a plurality of scrolling signals of computer pages.

15. The control system of claim 12, wherein the plurality of output signals is a plurality of key-pressing signals.

16. A control system of a computer peripheral, the control system comprising:
a receiving module for receiving a plurality of input signals;
a calculating module for calculating a reference frequency;
a determining module for determining whether the reference frequency is higher than a predetermined frequency; and
a transmitting module for transmitting a plurality of output signals successively to the computer when the reference frequency is higher than the predetermined frequency, wherein a transmitting frequency of the plurality of output signals is proportional to the reference frequency.

17. The control system of claim 16, wherein the reference frequency is a maximum value of frequencies of the plurality of receiving input signals, an average of the first three largest values of the frequencies of the plurality of receiving input signals, or an average of the frequencies of the plurality of receiving input signals.

18. The control system of claim 16, wherein the plurality of output signals is a plurality of scrolling signals of computer pages.

19. The control system of claim 16, wherein the plurality of output signals is a plurality of key-pressing signals.
